(19) United States
(12) Patent Application Publication
(10) Pub. No.: US 2012/0197674 A1
(43) Pub. Date: Aug. 2, 2012

(54) ESTIMATING A FUTURE PROJECT CHARACTERISTIC BASED ON THE SIMILARITY OF PAST PROJECTS

(76) Inventors: Maher Rahmouni, Bristol (GB); Marriane Hickey, Bristol (GB); Hiram Trimble Davis, (US)

(21) Appl. No.: 13/015,459

(22) Filed: Jan. 27, 2011

(51) Int. Cl. G06Q 10/00

(52) U.S. Cl. 705/7.11

(57) ABSTRACT

Disclosed embodiments relate to estimating a future project characteristic based on the similarity of past projects. For example, a processor may estimate a future project characteristic based on past projects and a similarity of each past project to the future project. In one embodiment, the processor then provides the estimation.

### BACKGROUND

Project planning, such as project planning for an information technology project, may be performed to predict information about a future project. For example, project planning may involve planning tasks, costs, and time commitments related to a future project. Project planning may in some cases be a time consuming and error prone task. For example, project planning may be a manual process involving discussions among multiple parties. In some cases, poor project planning may result in a compromised project.

### BRIEF DESCRIPTION OF THE DRAWINGS

In the accompanying drawings, like numerals refer to like components or blocks. The drawings describe example embodiments. The following detailed description references the drawings, wherein:

FIG. 1 is a block diagram illustrating one example of a computing system.

FIG. 2 is a flow chart illustrating one example of a method to estimate a characteristic of a future project based on the similarity of a past project.

FIG. 3 is a diagram illustrating one example of determining a preference for a future project task option.

FIG. 4 is a diagram illustrating one example of estimating the amount of a resource for a future project based on similarity information related to a past project.

FIG. 5 is a diagram illustrating one example of determining a deviation of an estimate of an amount of a resource for a future project based on similarity information related to a past project.

FIG. 6 is a diagram illustrating one example of predicting the likelihood of a scenario in a future project.

### DETAILED DESCRIPTION

Project planning may be used to predict information about a future project, such as an information technology project. Project planning tools, such as tools for creating generic templates, breaking down a high level task, and describing procedures for facilitating a project, may be used to plan future projects. However, these project tools often fail to provide accurate estimates of project specifications, such as the resources, time, cost, or tasks involved in a project.

In one embodiment, a project planning system estimates project factors based on factors in past projects and the degree of similarity between each past project and the future project. Information related to a past project that is more similar to the future project may be considered with more weight than information related to a past project that is less similar to the future project. For example, in estimating the cost of a future project, the cost of multiple past projects may be considered with more emphasis on the past projects with greater similarity to the future project. A project planning system in which past project characteristics are weighted based on a level of similarity may be used to predict multiple types of project characteristics. For example, the preference of a task option, the likelihood of a scenario occurring in the future project, or an amount of a resource may be estimated. The project planning system may predict the type and number of skills and assets likely to be used in a project. Using past projects and the degree of similarity of each past project to the future project may provide more accurate estimates.

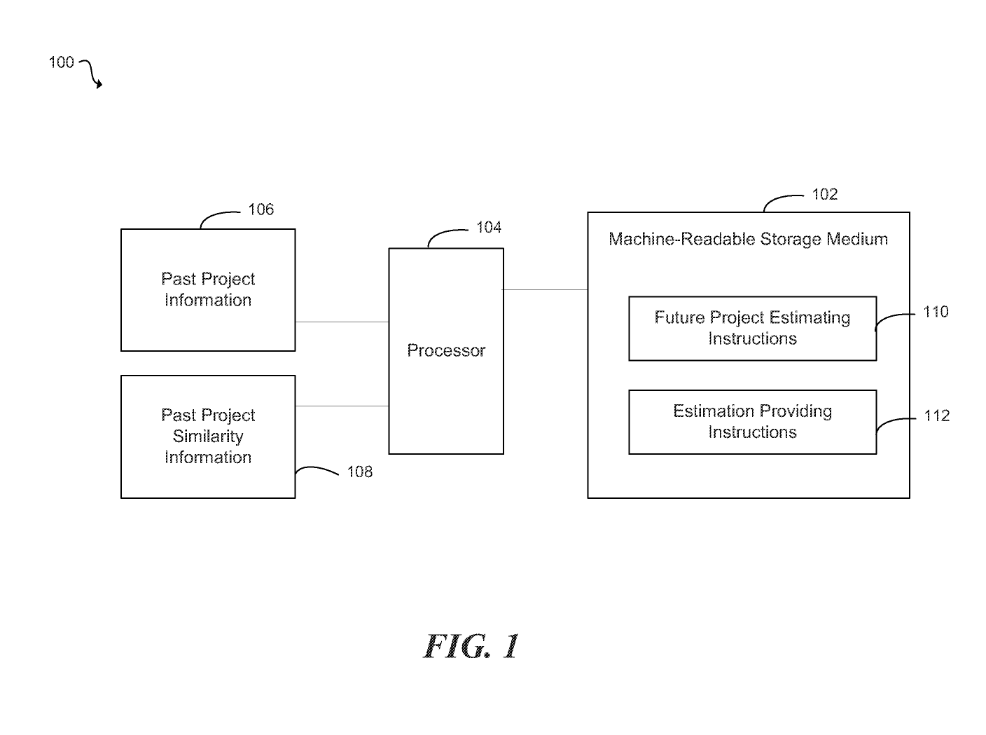

FIG. 1 is a block diagram illustrating one example of a computing system 100. The computing system 100 includes a processor 104, a machine-readable storage medium 102, past project information 106, and past project similarity information 108. The computing system 100 may be used to predict a measurement, such as cost or number of materials, related to a future project based on the value of the measurement in each of a group of past projects and a level of similarity between each past project and the future project and to provide the estimated measurement.

The processor 104 may be any suitable processor, such as a central processing unit (CPU), a semiconductor-based microprocessor, or any other device suitable for retrieval and execution of instructions. In one embodiment, the computing system 100 includes logic instead of or in addition to the processor 104. As an alternative or in addition to fetching, decoding, and executing instructions, the processor 104 may include one or more integrated circuits (ICs) or other electronic circuits that comprise a plurality of electronic components for performing the functionality described below. In one implementation, the computing system 100 includes multiple processors. For example, one processor may perform some functionality and another processor may perform other functionality. The processor 104 may be included in an electronic device, such as a personal computing device, mobile computing device, or server.

The past project information 106 may be any suitable past project information. For example, the past project information 106 may include information about the amount of a resource, such as time, money, equipment, or staff used in the past project. The past project information 106 may be related to any suitable past projects or subsets of past projects. The past projects may be related to any suitable type of project, such as technology related projects. For example, for deploying a hardware system in China, past projects for deploying a hardware system in England and deploying a hardware system in Mexico may be considered. The past projects may be pending or completed projects. In some cases, the past projects may be specifically selected, such as part of a template. The past projects may be selected based on their degree of similarity to the future projects, such as the top 10 most similar projects. The past project information 106 may be stored in any suitable location, such as in a non-volatile or volatile memory of the same electronic device as the processor 104 or in a remote database accessed by the processor 104 via a network.

The past project similarity information 108 may be any suitable similarity information, such as information indicating a similarity between each past project and a future project. The similarity may be in any suitable metric, such as a percentage or a qualitative value. For example, past project 5 may have a similarity level of 0.9 to the future project and past project 10 may have a similarity level of 0.4 to the future project. As another example, past project 4 may have a similarity level of medium and past project 6 may have a similarity level of high.

The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include instructions executable by the processor 104. The machine-readable storage medium 102 may be included in the system memory of an electronic device including the processor 104 where program instructions installed. In one embodiment, the machine-readable storage medium 102 is located on a memory of a server where installation files may be downloaded and installed.

The machine-readable storage medium 102 may include future project estimating instructions 110 and estimation providing instructions 112. The future project estimating instructions 110 may include instructions executable by the processor 104 to estimate a characteristic of a future project based on the characteristic in each of a group of past projects, such as the past project information 106, and a degree of similarity between each past project and the future project, such as the past project similarity information 108. For example, to estimate the cost of a future project, the cost of past projects may be taken into account where the cost of projects more similar to the future project is given greater weight. The estimation providing instructions 112 may include instructions executable by the processor 104 to provide the estimated characteristic of the future project. For example, the estimate may be stored, transmitted, or displayed.

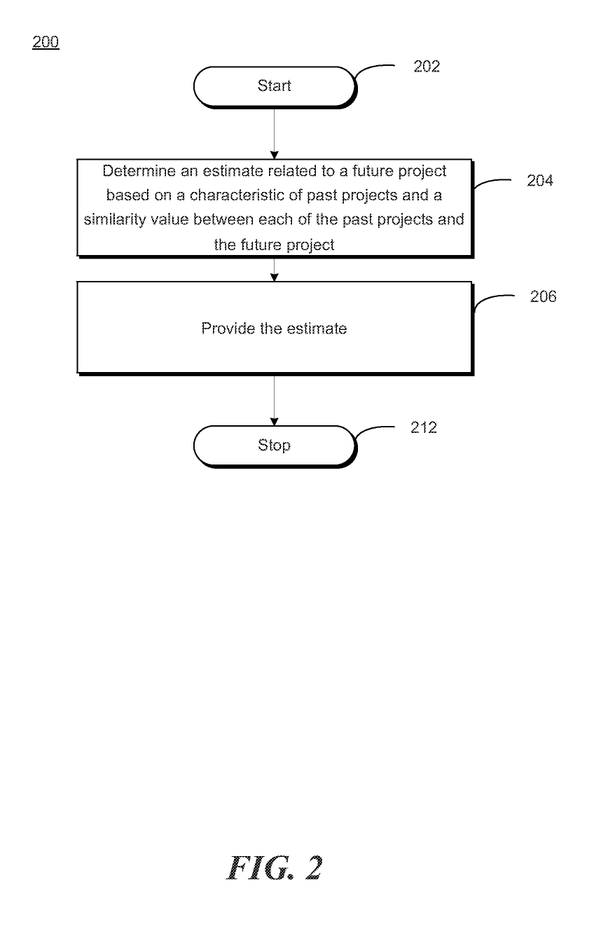

FIG. 2 is a flow chart illustrating one example of a method 200 to estimate a characteristic of a future project based on the similarity of a past project. In one embodiment, a processor estimates a characteristic for a future project by evaluating a characteristic in a past project in light of the similarity of the past project to the future project. For example, a characteristic associated with a past project that is more similar to the future project may be considered to be more relevant than a characteristic associated with a past project that is less similar to the future project. The processor may then provide the estimation information. For example, the estimation information may be stored, transmitted, or displayed. The method 200 may be implemented, for example, using the computing system 100. Using information about past projects and giving more weight to more relevant past projects may provide a better estimate of characteristics of a future project.

Beginning at 202 and moving to 204, a processor determines an estimate related to a future project based on a characteristic of past projects and a similarity value between each of the past projects and the future project. The processor may be any suitable processor, such as a Central Processing Unit. For example, the processor 104 may execute the future project estimating instructions 110 stored in the machine-readable storage medium 102.

The group of past projects may be any suitable past projects. The group of past projects may be manually selected from a pool of past projects. For example, a user may select projects the user deems to be relevant to the future project. The user may assign similarity values to each of the selected projects to indicate the degree of similarity to a future project. In one embodiment, a processor automatically selects a group of past projects. For example, a processor may determine the level of similarity between past projects and a future project and select projects with a similarity level to the future project above a particular threshold. The similarity of the projects may be determined in any suitable manner, such as based on the goal of the projects, the individual tasks likely to be involved, the type of staff used, or the type of resources, such as computer applications, likely to be used.

The degree of similarity between each past project and the future project may be any suitable similarity value, such as a description, percentage, or ranking. The similarity value associated with each past project may be automatically determined by a processor or assigned by a user. For example, a processor may compare factors associated with the past project and the future project to determine a similarity level. In some cases, a user may select multiple projects and assign a similarity level to each. The future project may be a specific future project. In one implementation, a template is created for estimating a resource amount for future projects in general. For example, a user may select past projects to analyze and assign a similarity value to each representing a weight to be associated with each project.

The estimated characteristic may be any suitable characteristic of the future project. For example, the estimated characteristic may be the amount of a resource likely to be used to complete the future project, such as an amount of time, money, materials, or staff. The estimated characteristic may be the probability of or preference for a particular task to be performed during the completion of the future project. The estimated characteristic may be a probability of a scenario occurring in a future project, such as the probability of using a type of staff or resource, the probability of spending over a particular amount, or the probability of failure. Other characteristics are also contemplated. In some implementations, the processor may estimate multiple types of characteristics of the future project.

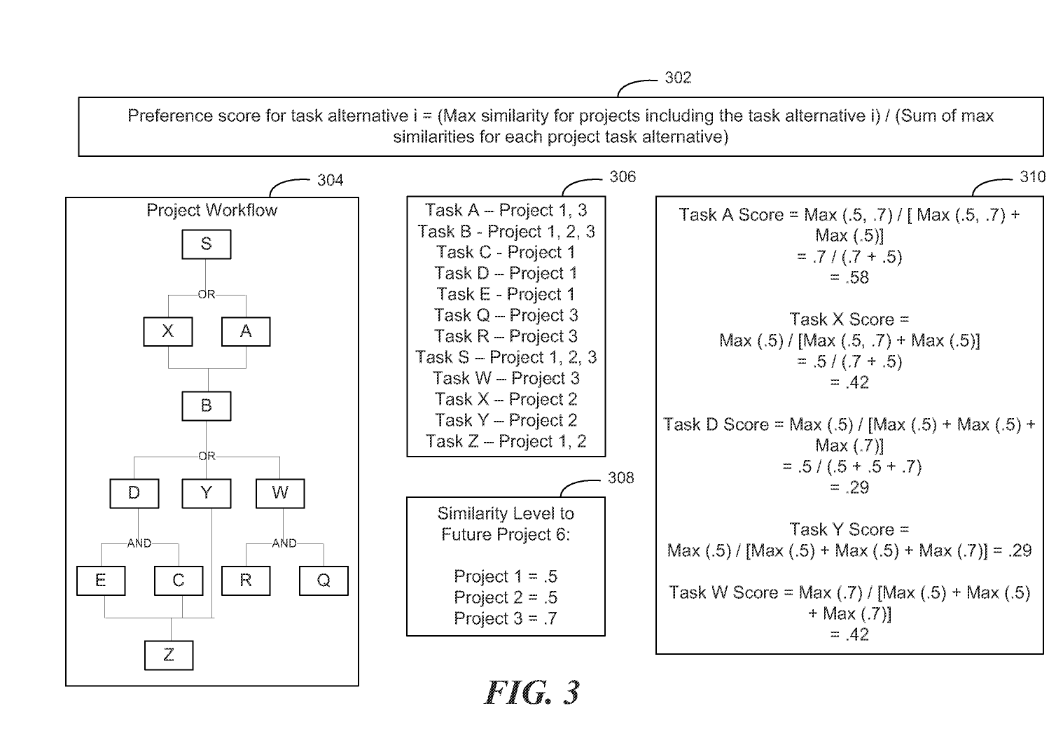

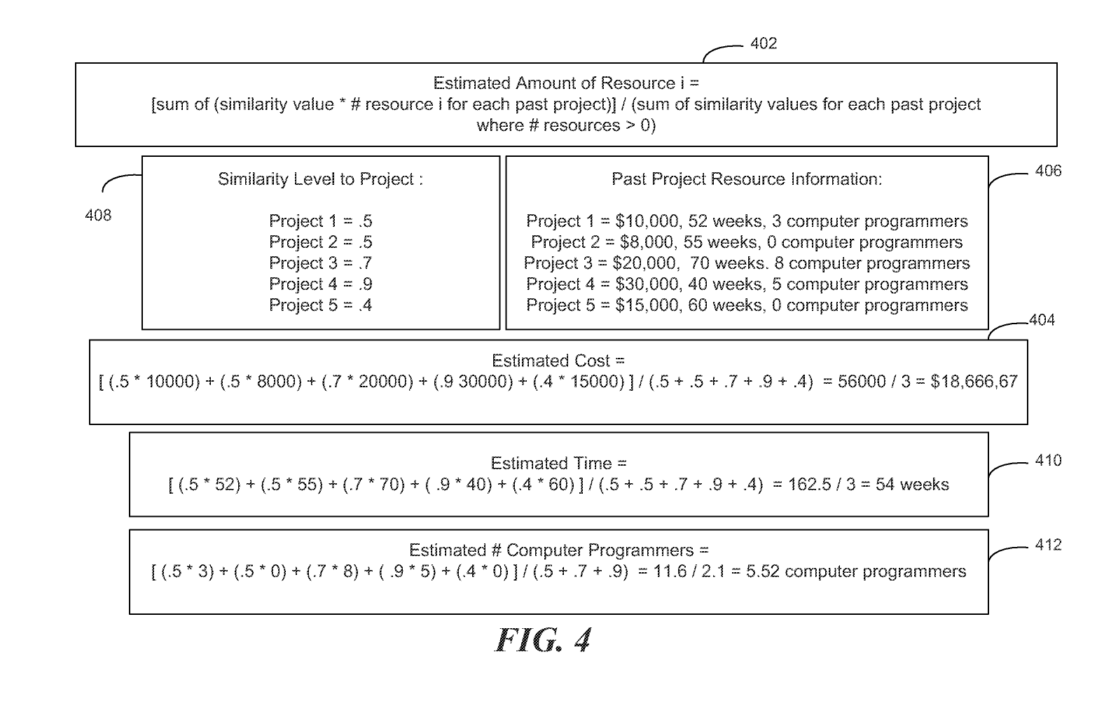

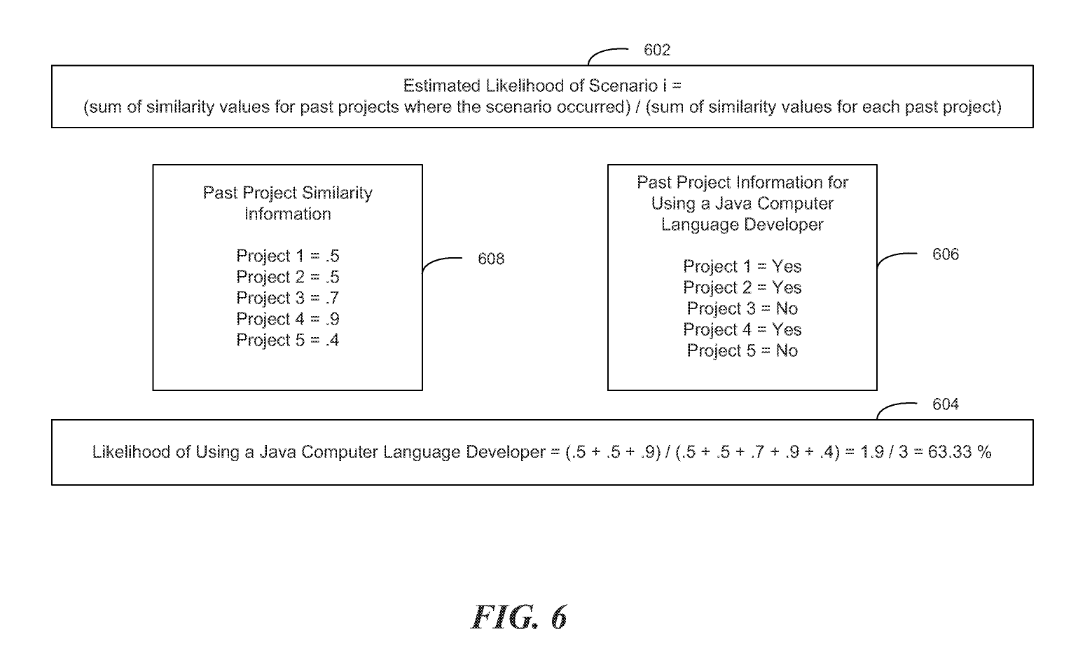

The processor may estimate a characteristic of the future project in any suitable manner. For example, the processor may determine weighted averages of the values of the characteristic associated with each of the past projects where the average is weighted based on each of the similarity values. FIGS. 3, 4, and 6 show example methods of predicting a characteristic of the future project. For example, FIG. 3 illustrates an example of predicting a probability of a future project including a particular task. FIG. 4 illustrates an example of predicting an amount of a type of resource, and FIG. 6 illustrates an example of predicting a probability of a scenario occurring in a future project.

Moving to 206, the processor provides the estimate. For example, the processor 104 may execute the estimation providing instructions 112 stored in the machine-readable storage medium 102. The processor may provide the estimated amount of the resource in any suitable manner. For example, the processor may transmit the estimated resource amount, such as to another electronic device via a network, store the estimated resource amount for later retrieval, or display the estimated resource amount on a display device associated with the processor. The provided estimate may be used for project planning. For example, a company may budget an estimated amount of money for the future project. In some cases, multiple estimates may be provided, such as a display of estimates for the amount of multiple types of materials and equipment likely to be used for a project. The method 100 continues to 108 to end.

FIG. 3 is a diagram illustrating one example of determining a preference for a future project task option. A processor, such as the processor 104, may estimate a probability of each task option being performed to complete a future project. For example, a project may include a list of tasks, and in some cases, the same project may be completed by performing multiple combinations of the possible tasks. Block 304 shows a project workflow with the boxes representing task options for the future project. For example, for a project of setting up a new data center may include tasks of staffing, design and testing. The tasks are represented by letters. The tasks are shown in a tree form. The project workflow may show tasks that are dependent one another, such as tasks and subtasks or a temporal dependency. An ‘or’ represents that alternatives are available, and an ‘and’ represents that tasks are performed as a group. For example, after task S, either task X or A may be performed. After task D, both tasks E and C are performed. Block 306 shows which projects include each task in the task workflow shown in block 304. For example, task A is included in projects 1 and 3, and task B is included in projects 1, 2, and 3.

Block 308 shows a list of similarity values associated with each project. For example, project 1 has a similarity value of 0.5 to the future project, project 2 has a similarity value of 0.5, and project 3 has a similarity value of 0.7. Project 3 is more similar to the future project than projects 1 and 2. As a result, information related to project 3 may be weighted more heavily than information related to projects 1 and 2.

Block 302 describes a method for determining a preference or probability score for each task alternative, such as where an ‘or’ is shown in the project task workflow in block 304. The preference may show a percentage or other preference value for each task alternative. For example, after task S, either task X or A may be performed, and a preference may be determined for each of task X and A to be used to facilitate a decision as to which task should be included in the future project.

Block 302 shows that the maximum similarity for a project including a particular task may be divided by the sum of the maximum similarity values for each of the tasks that are options. For determining a score for a preference between task X and A, the score for task X may be the maximum similarity value for a project associated with task X divided by the sum of the maximum similarity values associated with task X and task A. Project 2 is associated with task X, and projects 1 and 3 are associated with task A. The maximum similarity of projects associated with task X is the similarity value for project 2, which is 0.5. The sum of the maximum similarity for tasks X and A is the maximum similarity value for task X, 0.5, plus the maximum similarity value for task A, the maximum of 0.5 associated with project 1 and 0.7 associated with project 3. The resulting determinations is 0.5 (0.5+0.7)=0.42 or 42%. The preference for task A may be calculated individually. In some cases, the preference for task A may be determined by 1 minus the preference for task X because the preference for the total options at a decision point may equal 100%. There is a 58% preference for performing task A versus a 42% preference for performing task X. Block 310 similarly shows the determination of a preference score for other task options in the project workflow of block 304.

The task preference may be used in any suitable manner. For example, a user may decide which tasks to complete for a future project or the order in which the tasks should be completed based on a preference score. In some cases, a user may determine the probability that a task will be included in a project to better estimate resources that may be associated with the particular tasks likely to be part of the future project.

In one embodiment, a processor, such as the processor 104, estimates the amount of a resource to be used in a future project, such as the amount of money, time, staff, equipment, or materials. The estimation may be based on past projects and the level of similarity between each of the past projects and the future project.

FIG. 4 is a diagram illustrating one example of estimating the amount of a resource for a future project based on similarity information related to a past project. Block 402 shows the estimated amount of resource i determined by [sum of (similarity value*# resource i for each past project)]/(sum of similarity values for each past project where # resources>0). In some cases, the sum of similarity values for each past project may be used even if the number of a resource is equal to zero for the project. Block 408 shows example past projects with similarity values. For example, project 1 has a similarity value of 0.5 to the future project. Block 406 shows resource information associated with the past projects. For example, project 1 cost $10,000, took 52 weeks to complete, and used 3 computer programmers.

Block 404 shows an implementation of the method in block 402 to determine an estimated cost of the future project. For example the method includes: [(similarity of project 1*cost of project 1)+(similarity of project 2*cost of project 2)+(similarity of project 3*cost of project 3)+(similarity of project 4*cost of project 4)+(similarity of project 5*cost of project 5)]/(similarity of project 1+similarity of project 2+similarity of project 3+similarity of project 4+similarity of project 5). The estimated cost for the future project is $18,666.67.

Block 910 shows determining an estimation of the time used for the future project using the similarity of the projects 1-5 and the time associated with the projects 1-5. The method includes: [(similarity of project 1*time of project 1)+(similarity of project 2*time of project 2)+(similarity of project 3*time of project 3)+(similarity of project 4*time of project 4)+(similarity of project 5*time of project 5)]/(similarity of project 1+similarity of project 2+similarity of project 3+similarity of project 4+similarity of project 5). The estimated time to complete the future project is 54 weeks.

Block 412 shows determining an estimation of the number of computer programmers likely to be used for the future project. Projects 2 and 5 used 0 computer programmers. As a result the similarity values for projects 2 and 5 are not included in the sum in the denominator. The method includes: [(similarity of project 1*# of computer programmers of project 1)+(similarity of project 2*# of computer programmers of project 2)+(similarity of project 3*# of computer programmers of project 3)+(similarity of project 4*# of computer programmers of project 4)+(similarity of project 5*# of computer programmers of project 5)]/(similarity of project 1+similarity of project 3+similarity of project 5). The estimate is 5.52 computer programmers to be used to complete the future project.

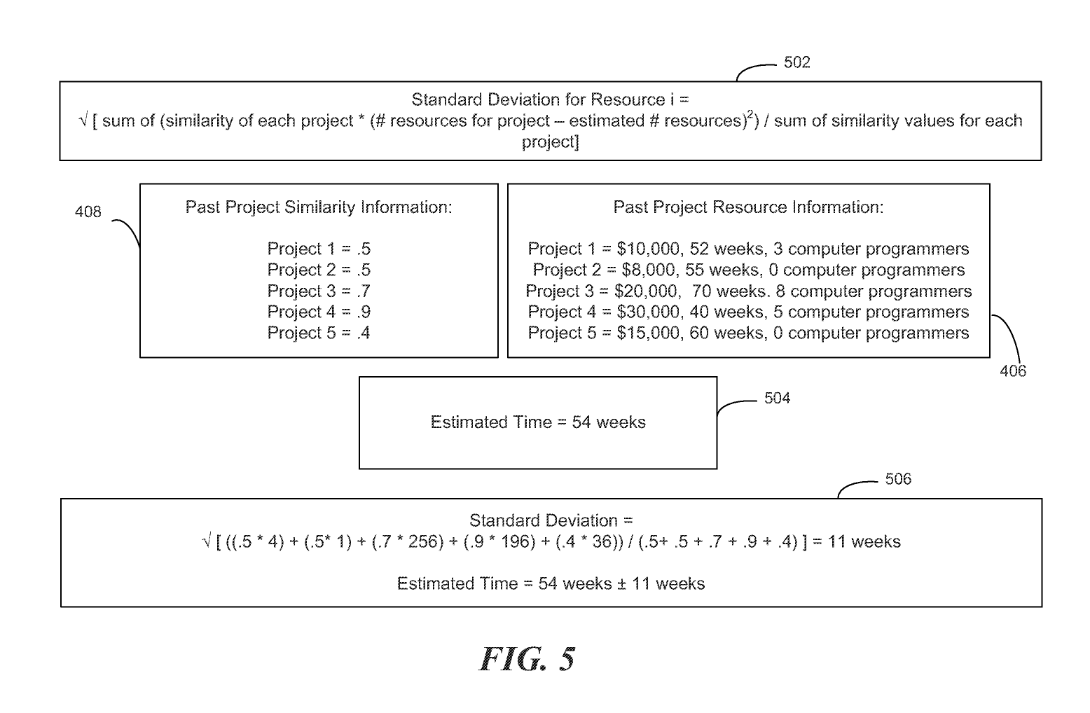

FIG. 5 is a diagram illustrating one example of determining a deviation of an estimate of an amount of a resource for a future project based on similarity information related to a past project. In some cases, the processor may determine a deviation from an estimated amount of a resource indicating a range for the resource. The deviation may indicate a level of accuracy for the estimate. For example, an estimate of a cost of $5000 with a deviation of $1000 may indicate that the cost is likely to be between $4000 and $6000.

Block 502 shows a method for determining a deviation of an estimate of an amount of a resource i. Block 408 shows the past project similarity information from FIG. 4, and block 406 shows the past project resource information from FIG. 4. Block 504 shows the estimated time of 54 weeks determined in 910.

Block 502 shows a method for determining a deviation from an estimate. The method includes: √[sum of (similarity of each project*(# resources for project−estimated # resources)²)/sum of similarity values for each project]. Block 506 shows using the method of block 502 to determine a deviation of the estimated time. The result is a deviation of 11 weeks, indicating that the range for the time estimate is 43 weeks to 65 weeks.

In one embodiment, the likelihood of a scenario for a future project may be estimated based on similarity information related to a past project. The likelihood of the event occurring may be based on the similarity of the projects in which the event occurred or based on the similarity of the projects in which the event did not occur. The likelihood of the scenario in the future project may be calculated in any suitable manner. For example, the projects in which a scenario occurred may be compared to the past projects, including the projects where the scenario did occur and the projects where the scenario did not occur. In one implementation, the projects in which a scenario occurred and the similarity values related to those projects are compared to the sum of the similarity values from both projects in which the scenario did occur and did not occur. In one implementation, the projects in which a scenario did not occur and the similarity values related to those projects are compared to the sum of the similarity values from both projects in which the scenario did occur and did not occur.

FIG. 6 is a diagram illustrating one example of predicting the likelihood of a scenario in a future project. A block 606 shows a method for estimating the likelihood of scenario i by (sum of similarity values for past projects where the scenario occurred)/(sum of similarity values for each past project). Block 608 shows a list of projects and corresponding similarity values. Block 606 shows past project information for a scenario of using a Java computer language developer. For example, projects 1, 2, and 4 used a Java computer language developer. Block 604 shows determining the likelihood of using a Java computer language developer in a future project by dividing the sum of the similarity values for projects 1, 2, and 4 by the sum of the similarity values for projects 1-5. The result shows that there is a 63.33% chance of the future project using a Java computer language developer. As a converse, there is a 36.66% chance of the future project not using a Java computer language developer.

Determining an estimate for a future project may be based on past projects. Considering the similarity of the past projects to the future project may provide a more accurate estimate. For example, a future project may include similar characteristics, such as similar tasks and resources, to past projects that are more closely related to the future project. More accurate estimates may lead to better allocation of time and resources to a project.

1. A computing system to estimate a characteristic of a future project, comprising:
a processor to:
predict a measurement related to a future project based on the value of a measurement in each of a group of past projects and a level of similarity between each past project and the future project; and
provide the predicted measurement.

2. The computing system of claim 1, wherein the predicted measurement comprises at least one of: an amount of a resource, a likelihood of an event, and a probability of including a particular task option.

3. The computing system of claim 2, wherein the predicted measurement comprises a probability of including a particular task option; and
wherein the processor predicts the measurement by evaluating the similarity to the future project of past projects including the particular task option.

4. The computing system of claim 3, wherein predicting the measurement further comprises evaluating the similarity to the future project of past projects including an alternative to the particular task.

5. A method to estimate a characteristic of a future project, comprising:
determining, by a processor, an estimate related to a future project based on a characteristic of past projects and a similarity value between each of the past projects and the future project; and
providing, by a processor, the estimate.

6. The method of claim 5, wherein the characteristic comprises at least one of: a probability of a scenario, the number of a resource, and a preference of a task option.

7. The method of claim 6, wherein the characteristic comprises a probability of a scenario and wherein determining an estimate comprises comparing the similarity values of past projects including the scenario to the similarity values of past projects including and not including the scenario.

8. The method of claim 6, wherein the characteristic comprises a probability of a scenario and wherein determining an estimate comprises:
determining a sum of each similarity value of each past project where the scenario occurred; and
determining a ratio between the determined sum and a sum of the similarity values of each of the past projects.

9. The method of claim 6, wherein the probability of a scenario comprises the probability of using a particular staffing role in a future project.

10. A machine-readable storage medium including instructions executable by a processor to implement method, the method comprising:
estimating a characteristic of a future project based on a characteristic in each of a group of past projects and a degree of similarity between each past project and the future project; and
providing the estimated characteristic of the future project.

11. The machine-readable storage medium of claim 10, wherein the characteristic comprises at least one of: an amount of a resource, a likelihood of a scenario, and a probability of including a task.

12. The machine-readable storage medium of claim 11, wherein the amount of a resource comprises at least one of:
a number of staff members in a particular role;
an amount of money; and
an amount of time.

13. The machine-readable storage medium of claim 11, wherein the characteristic comprises the amount of a resource and wherein estimating the amount of the resource comprises evaluating for each past project the degree of similarity of the past project compared to the amount of the resource in the past project.

14. The machine-readable storage medium of claim 13, wherein estimating the amount of the resource further comprises comparing the evaluation to a sum of the degree of similarity of each past project.

15. The machine-readable storage medium of claim 11, wherein the characteristic comprises the amount of a resource and where estimating the amount of the resource comprises estimating the amount of a resource based on a degree of similarity associated with each of the past projects where the amount of the resource is greater than zero.
